(19) United States
(12) Patent Application Publication
(10) Pub. No.: US 2013/0097591 A1
(43) Pub. Date: Apr. 18, 2013

(54) THREAD-SPECIFIC WATCH EVENT ADMINISTRATION IN A NON-STOP DEBUGGING ENVIRONMENT

(71) Applicant: International Business Machines Corporation, Armonk, NY (US)

(72) Inventor: CARY L. BATES, ROCHESTER, MN (US)

(73) Assignee: INTERNATIONAL BUSINESS MACHINES CORPORATION, ARMONK, NY (US)

(21) Appl. No.: 13/693,802

(22) Filed: Dec. 4, 2012

Related U.S. Application Data
(63) Continuation of application No. 13/085,647, filed on Apr. 13, 2011.

(51) Int. Cl. G06F 11/36

(52) U.S. Cl. CPC G06F 11/3664
USPC 717/125

(57) ABSTRACT

A non-stop debugging environment includes a debugger configured to debug a multi-threaded debuggee, where encountering an event by one of threads stops execution of only the one thread without concurrently stopping execution of other threads. In the non-stop debugging environment, thread-specific watch event administration includes holding from execution, by the debugger, a thread triggering a watch event; determining, by the debugger, whether the watch event was set for the thread triggering the watch event; if the watch event was set for the thread triggering the watch event, setting, by the debugger, the debug perspective of a GUI to the thread triggering the watch event; and, if the watch event was not set for the thread triggering the watch event: retrieving, by the debugger, watch event information from the thread triggering the watch event; and resuming, by the debugger without user interaction, execution of the thread triggering the watch event.

### CROSS-REFERENCE TO RELATED APPLICATION

This application is a continuation application of and claims priority from U.S. patent application Ser. No. 13/085,647, filed on Apr. 13, 2011.

### BACKGROUND OF THE INVENTION

1. Field of the Invention

The field of the invention is data processing, or, more specifically, methods, apparatus, and products for thread-specific watch event administration in a non-stop debugging environment.

2. Description of Related Art

Software source code is increasingly complex and execution of such software may be multi-threaded. Software development is evolving to provide enhanced methods of debugging multi-threaded software applications. In traditional debugging, an event encountered by any one thread stops execution of all threads of the multi-threaded solution. This form of debugging may be referred to as ‘all-stop’ debugging. in contrast to all-stop debugging, the enhanced multi-threaded debugging enables an event encountered by one thread to stop only that one thread's execution while all other threads remain executing. This form of debugging is referred to as non-stop debugging. Non-stop debugging is a bit of a misnomer, however, in that some threads actually do stop execution. The primary difference between non-stop and all stop debugging, is that in non-stop debugging execution of all threads of a multi-threaded program need not be stopped upon a single thread encountering an event, while in all-stop debugging execution of all threads is stopped upon a single thread of the multi-threaded application encountering an event. While non-stop debugging provides many benefits, non-stop debugging also presents many challenges.

### SUMMARY OF THE INVENTION

Methods, apparatus, and products for thread-specific watch event administration in a non-stop debugging environment are disclosed in this specification. The non-stop debugging environment includes a debugger configured to debug a debuggee. The debuggee includes a number of threads of execution. In the non-stop debugging environment encountering an event by one of threads stops execution of only the one thread without concurrently stopping execution of other threads. Also in the non-stop debugging environment, thread-specific watch event administration includes: holding from execution, by the debugger, a thread triggering a watch event; determining, by the debugger, whether the watch event was set for the thread triggering the watch event; if the watch event was set for the thread triggering the watch event, setting, by the debugger, the debug perspective of a graphical user interface (‘GUI’) to the thread triggering the watch event; and if the watch event was not set for the thread triggering the watch event: retrieving, by the debugger, watch event information from the thread triggering the watch event; and resuming, by the debugger without user interaction, execution of the thread triggering the watch event.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for thread-specific watch event administration in a non-stop debugging environment according to embodiments of the present invention.

FIG. 2 sets forth an example non-stop debugging GUI presented to a user in accordance with embodiments of the present invention.

FIG. 3 sets forth a flow chart illustrating an exemplary method for thread-specific watch event administration in a non-stop debugging environment according to embodiments of the present invention.

FIG. 4 sets forth a flow chart illustrating a further exemplary method for thread-specific watch event administration in a non-stop debugging environment according to embodiments of the present invention.

### DETAILED DESCRIPTION OF EXEMPLARY EMBODIMENTS

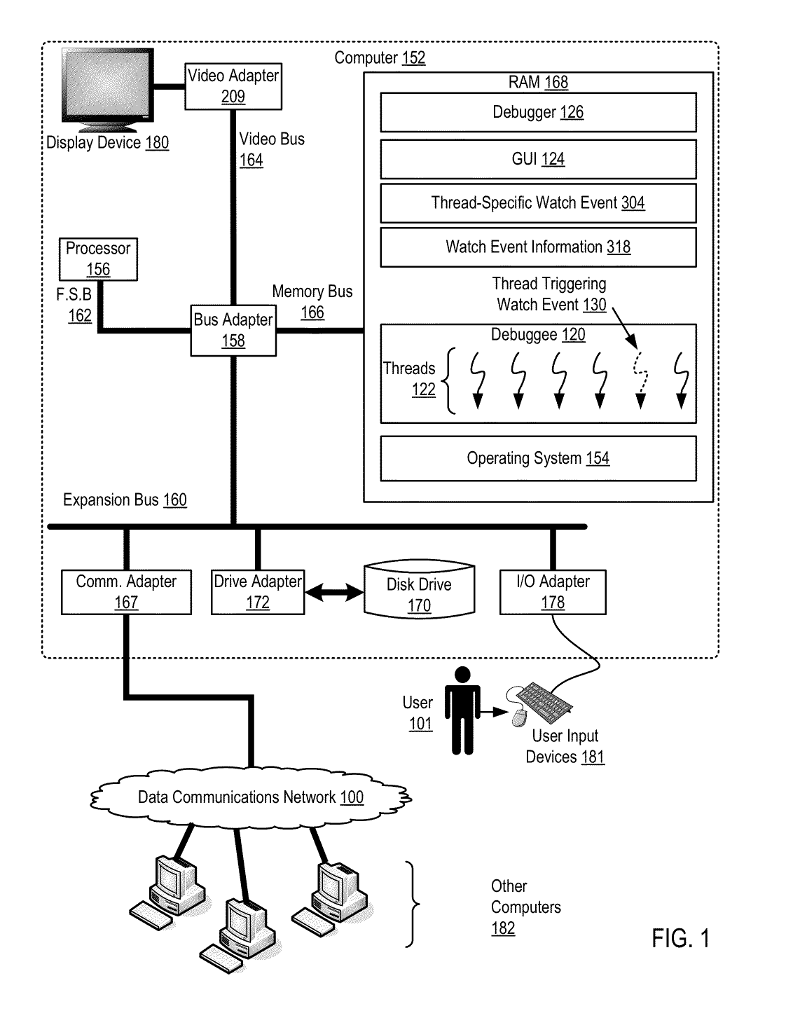

Exemplary methods, apparatus, and products for thread-specific watch event administration in a non-stop debugging environment in accordance with the present invention are described with reference to the accompanying drawings, beginning with FIG. 1. FIG. 1 sets forth a block diagram of a system for thread-specific watch event administration in a non-stop debugging environment according to embodiments of the present invention. The system of FIG. 1 includes automated computing machinery comprising an exemplary computer (152) useful in thread-specific watch event administration in a non-stop debugging environment according to embodiments of the present invention. The computer (152) of FIG. 1 includes at least one computer processor (156) or ‘CPU’ as well as random access memory (168) (RAM') which is connected through a high speed memory bus (166) and bus adapter (158) to processor (156) and to other components of the computer (152).

Stored in RAM (168) are a debugger (126) and a debuggee (120). A debugger (126) is an application that controls operation of another application—the debuggee (120)—for the purpose of testing execution of the debuggee. The source code of the debuggee may run on an instruction set simulator (ISS), a technique that allows great power in its ability to halt when specific conditions are encountered but which will typically be somewhat slower than executing the code directly on a processor for which the code is written. When execution of a program crashes or reaches a preset condition, a debugger typically displays the position in the source code at which the execution of the program crashed. A ‘crash’ occurs when the program cannot normally continue because of a programming bug. In addition to displaying a position in source code when execution of the source code crashes, debuggers also often offer other functions such as running a program step by step (single-stepping or program animation), stopping, breaking, or pausing the program to examine the current state, at some event or specified instruction by means of a breakpoint, and tracking the values of some variables.

In the example system of FIG. 1, the debugger (126) presents a graphical user interface (124) as a front-end of the debugger (126). Front-ends are extensions to debugger engines that provide Integrated Development Environment (IDE') integration, program animation, and visualization features, rather than console-based command line interfaces. The ‘front-end’ directly faces a client—or user—in contrast to the debugger (126) in the example of FIG. 1, which interfaces indirectly with the clients through the GUI (124).

In the example system of FIG. 1, the debuggee (120) is a software application that executes as a process containing a number of threads (122) of execution. A ‘thread’ of execution as the term is used here refers to the smallest unit of processing that can be scheduled by an operating system. A thread generally results from a fork of a computer program into two or more concurrently running threads. The implementation of threads and processes differs from one operating system to another, but in most cases, a thread is contained inside a process. Multiple threads can exist within the same process and share resources such as memory, while different processes do not share these resources. In particular, the threads of a process share the process's computer program instructions and its context—the values that the process's variables reference at any given moment.

The system of FIG. 1 includes a non-stop debugging environment that includes the debugger (126) and the debuggee (120). The debugger supports non-stop debugging by insuring that when one thread of a multi-threaded debuggee encounters an event, execution of only that one of threads stops, without concurrently stopping execution of other threads. Consider, for example, a multi-threaded debuggee that includes three threads. In a non-stop debug environment, when one of the threads encounters an event, execution of that thread is stopped, but execution of the remaining two threads continues unabated. Either of other two threads may then separately encounter an event, stopping execution of that thread, but no other thread. By contrast, a traditional all-stop debugging environment insures that all threads are stopped concurrently with any one thread encountering an event. Continuing with the above example of a triple threaded debuggee, when any one of the three threads encounters an event in a traditional all-stop debug environment, all three threads halt execution.

An event is a predefined occurrence during execution of a debuggee. Examples of events which may be encountered during execution of the debuggee include breakpoints, watchpoints, catchpoints, and the like. A breakpoint is a specification of a source code location at which a debuggee will pause or stop execution. A watchpoint is a breakpoint configured to pause or stop execution of the debuggee when a value of a particular expression changes. A catchpoint is another type of breakpoint configured to pause or stop execution of the debuggee when a specified event occurs such as the throwing of an exception or a load of a library, and so on.

In addition to supporting non-stop debugging, the debugger (126) in the example of FIG. 1 is also configured for thread-specific watch event administration in the non-stop debugging environment in accordance with embodiments of the present invention. Thread-specific watch event administration in accordance with embodiments of the present invention includes setting, by the debugger (126), a watch event for a thread. A watch event or ‘watchpoint’ is an event triggered by a modification of a value of a variable in source code. Writing a new value or reading the value of the variable, for example, may trigger a watch event. A watch event may be ‘set for a thread’ in that a user may specify a thread to be associated with a watch event. That is, a user may desire to view debug results associated with only a particular thread upon a trigger of a watch event. In the example of FIG. 1, the debugger may also support thread-specific watch event administration in accordance with embodiments of the present invention by holding from execution a thread (130) triggering a watch event and determining, by the debugger (126), whether the watch event was set for the thread triggering the watch event. If the watch event was set for the thread triggering the watch event, the debugger (126) may then set the debug perspective of a graphical user interface (‘GUI’) (124) to the thread triggering the watch event. The ‘debug perspective’ is a display of information related to a particular thread. In debuggers that are not configured for non-stop debugging, the debug perspective is switched, upon a breakpoint encounter, to display information describing the thread that encountered the breakpoint.

If the watch event was not set for the thread triggering the watch event, the debugger (126) is configured to retrieve watch event information (318) from the thread (130) triggering the watch event and resume, without user (101) interaction, execution of the thread triggering the watch event. Watch event information is any data describing the triggering of the watch event. Thread identifiers, current and previous values of a variable for which the watch event was set, and so on, are all examples of watch event information which may be gathered prior to resuming execution of the thread triggering the watch event.

In some embodiments, watch event information includes a location in source code of one or more computer program instructions being executed and triggering the watch event. In retrieving such watch event information, for example, a debugger may retrieve the present program counter value from a register and map a portion of source code with the program counter value. Watch event information may also specify an address of one or more computer program instructions, a function name or function call, a library, or any source that triggered the watch event.

Also stored in RAM (168) is an operating system (154). Operating systems useful in computers that carry out thread-specific watch event administration in a non-stop debugging environment according to embodiments of the present invention include UNIX™ Linux™ Microsoft XP™, AIX™, IBM's i™, and others as will occur to those of skill in the art. The operating system (154), debugger (126), debuggee (126), and GUI (124) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers that operate for thread-specific watch event administration in a non-stop debugging environment according to embodiments of the present invention include Integrated Drive Electronics (‘IDE’) adapters, Small Computer System Interface (SCSI') adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output ('I/O′) adapters (178). I/O adapters implement user-oriented input/output through, for example, software drivers and computer hardware for controlling output to display devices such as computer display screens, as well as user (101) input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for thread-specific watch event administration in a non-stop debugging environment according to embodiments of the present invention include modems for wired dial-up communications, Ethernet (IEEE 802.3) adapters for wired data communications network communications, and 802.11 adapters for wireless data communications network communications.

The arrangement of computers, networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

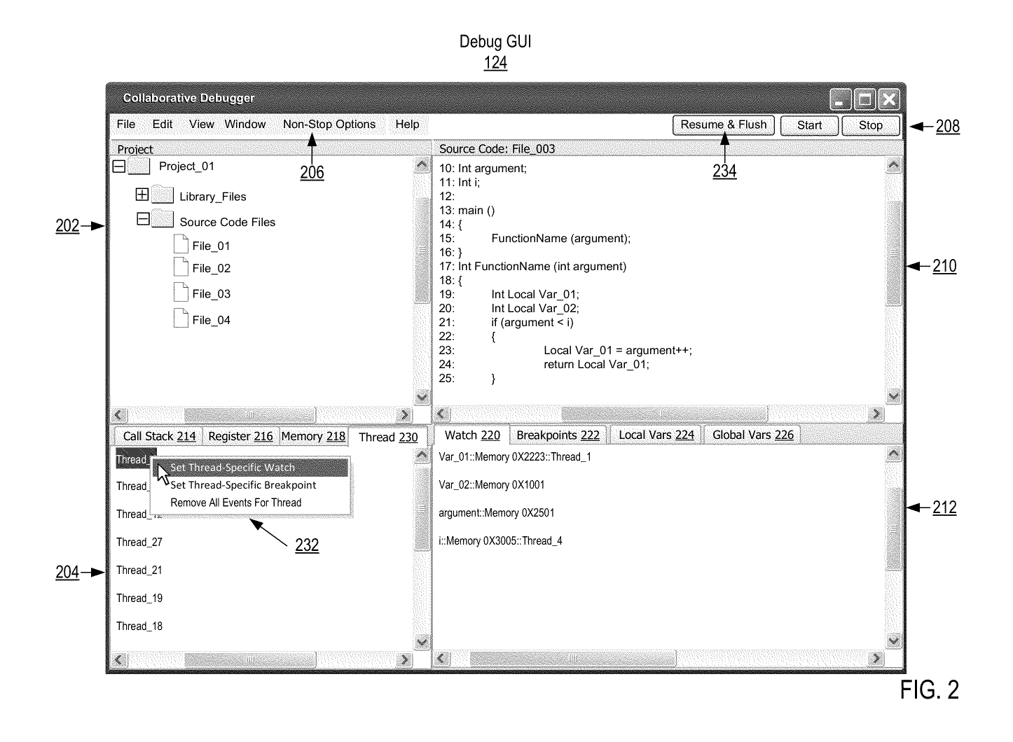

For further explanation, FIG. 2 sets forth an example non-stop debugging GUI (124) presented to a user in accordance with embodiments of the present invention. The example GUI (124) of FIG. 2 provides an interface for a user to control operation of a debugger that supports non-stop debugging. The debugger presenting the example GUI (124) of FIG. 2 is configured to debug a multi-threaded debuggee. That is, the debugger presenting the example GUI (124) of FIG. 2 and the multi-threaded debuggee form a non-stop debugging environment.

The example GUI (124) of FIG. 2 includes a menu bar (208) that, in turn, includes a number of separate menus: a File menu, an Edit menu, a View menu, a Non-Stop Options menu, and a Help menu. The Non-Stop Options menu (206), when selected, may provide a user with various menu items that support non-stop debugging.

The example GUI (124) of FIG. 2 also includes several independent portions—called panes (as in ‘window panes’) for clarity of explanation—a project pane (202), a source code pane (210), and two separate data panes (204, 212). Project pane (202) presents the files and resources available in a particular software development project. Source code pane (210) presents the source code of the multi-threaded debuggee. The data panes (204, 212) present various data useful in debugging the source code. In the example of FIG. 2, data pane (204) includes four tabs, each of which presents different data: a call stack tab (214), a register tab (214), a memory tab (218), and a threads tab (230). Data pane (212) includes four tabs: a watch list tab (220), a breakpoints (222) tab, a local variable tab (224), and a global variable tab (226).

The GUI (124) of FIG. 2 may support thread-specific watch event administration in a non-stop debugging environment in accordance with embodiments of the present invention. A user in the example of FIG. 2 has selected a thread, Thread_1, and the GUI (124) has displayed a drop-down selection list (232) that includes three separate options: an option to set a thread-specific watch for the selected thread, an option to set a thread-specific breakpoint for the selected thread, and an option to remove all thread-specific events for the selected thread. Upon selection of the option to set a thread-specific watch event, the debugger presenting the example GUI (124) of FIG. 2 may set a watch event for the selected thread. The debugger may set such a watch event by establishing a watch on a user-selected variable and by storing an association, in a data structure such as a table, of the thread identifier, Thread_1, and the watched variable.

Once set, the debugger may operate by holding from execution a thread triggering a watch event, determining whether the watch event was set for the thread triggering the watch event and, if the watch event was set for the thread triggering the watch event, setting the debug perspective of a GUI (124) to the thread triggering the watch event, That is, if Thread_1 is the thread to encounter the watch event, the debug GUI (124) will display information describing Thread_1 as well as watch event information describing the watched variable. If the watch event was not set for the thread triggering the watch event, the debugger presenting the example GUI (124) of FIG. 2 may retrieve watch event information from the thread triggering the watch event and resuming, by the debugger without user interaction, execution of the thread triggering the watch event. Such retrieved watch event information may be available to the use, displayed on request, displayed in a predefined portion of the GUI (124), stored for later display upon a trigger of the watch event by the thread for which the watch event was set, and so on as will occur to readers of skill in the art.

The GUI items, menus, window panes, tabs, and so on depicted in the example GUI (124) of FIG. 2, are for explanation, not for limitation. Other GUI items, menu bar menus, drop-down menus, list-boxes, window panes, tabs, and so on as will occur to readers of skill in the art may be included in GUIs presented by a debugger in a system configured for non-stop debugging in accordance with embodiments of the present invention.

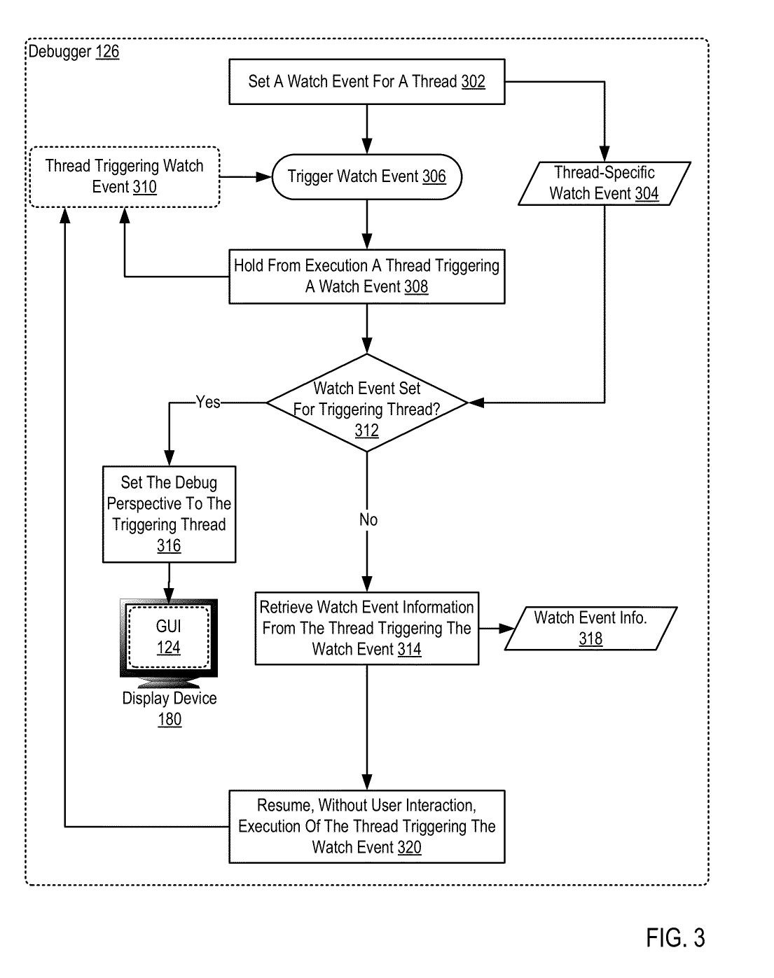

For further explanation, FIG. 3 sets forth a flow chart illustrating an exemplary method for thread-specific watch event administration in a non-stop debugging environment according to embodiments of the present invention. The non-stop debugging environment of FIG. 3 includes a debugger (126) configured to debug a multi-threaded debuggee. In the non-stop debugging environment, encountering an event by one of threads stops execution of only the one thread without concurrently stopping execution of other threads.

The method of FIG. 3 includes setting (302), by the debugger (126), a watch event for a thread. Setting (302) a watch event for a thread may include establishing the watch event and storing, in a data structure such as a thread-specific watch event table, an association of the watch event and a thread identifier.

The method of FIG. 3 also includes holding (308) from execution, by the debugger (126), a thread (310) triggering (306) a watch event (304) and determining (312), by the debugger (126), whether the watch event (304) was set for the thread (310) triggering (306) the watch event. Determining (312) whether the watch event (304) was set for the thread (310) triggering (306) the watch event may be carried out by searching in a thread-specific watch event table (or other data structure) for a record associating the watch event and thread identifier of the thread triggering the watch event.

If the watch event was set for the thread triggering the watch event, the method of FIG. 3 continues by setting (316), by the debugger (126), the debug perspective of a graphical user interface (‘GUI’) (124) to the thread (310) triggering the watch event. If the watch event (304) was not set for the thread (310) triggering (306) the watch event (304), the method of FIG. 3 continues by retrieving (314), by the debugger (126), watch event information (318) from the thread (310) triggering the watch event and resuming (320), by the debugger (126) without user interaction, execution of the thread triggering the watch event. Retrieving (314) watch event information (318) from the thread (310) triggering the watch event may be carried out in various ways including, for example, by retrieving the thread's program counter, which may map to a line or other location in source code that, upon execution, triggered the watch event.

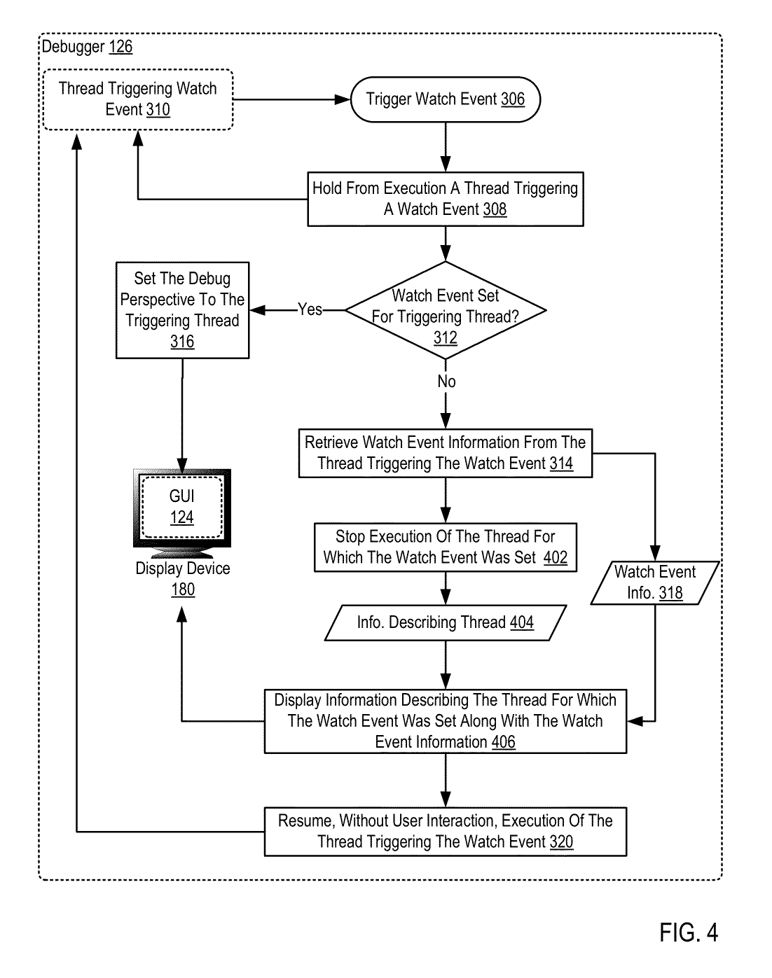

For further explanation, FIG. 4 sets forth a flow chart illustrating a further exemplary method for thread-specific watch event administration in a non-stop debugging environment according to embodiments of the present invention. The method of FIG. 4 is similar to the method of FIG. 3 in that the non-stop debugging environment of the method of FIG. 4 also includes a debugger (126) configured to debug a multi-threaded debuggee, where encountering an event by one of threads stops execution of only the one thread without concurrently stopping execution of other threads. The method of FIG. 4 is also similar to the method of FIG. 3 in that the method of FIG. 4 includes holding (308) from execution a thread triggering a watch event; determining (312) whether the watch event was set for the thread triggering the watch event; if the watch event was set for the thread triggering the watch event, setting (316) the debug perspective of a graphical user interface (‘GUI’) to the thread triggering the watch event; and, if the watch event was not set for the thread triggering the watch event: retrieving (314) watch event information from the thread triggering the watch event; and resuming (320), without user interaction, execution of the thread triggering the watch event.

FIG. 4 differs from the method of FIG. 3, however, in that the method of FIG. 4 includes stopping (402), by the debugger, execution of the thread for which the watch event was set if the watch event was not set forth the tread triggering the watch event. That is, in addition to holding the thread triggering the watch event from execution, the debugger (126) may also be configured to stop the execution of the thread for which the watch event was set. Stopping (402) execution of the thread for which the watch event was set may be carried out by determining from a thread-specific watch event table a thread identifier of the thread for which the triggered watch event (306) was set and with a system call, exception, trap, insertion of a predefined opcode, and the like, causing execution of the thread to halt.

The method of FIG. 4 also includes displaying (406), by the debugger (126) in the GUI (124), information (404) describing the thread for which the watch event was set along with the watch event information retrieved from the thread triggering the watch event. In this way, the debug perspective is set to the thread for which the watch event was set, even when the watch event is triggered by another thread. Further, watch event information may be displayed—source code location, variable values, and so on—along with information describing the thread for which the watch event was set.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable transmission medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable transmission medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable transmission medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of thread-specific watch event administration in a non-stop debugging environment, the non-stop debugging environment comprising a debugger configured to debug a debuggee comprising a plurality of threads of execution, wherein encountering an event by one of threads stops execution of only the one thread without concurrently stopping execution of other threads, the method comprising:
holding from execution, by the debugger, a thread triggering a watch event;
determining, by the debugger, whether the watch event was set for the thread triggering the watch event;
if the watch event was set for the thread triggering the watch event, setting, by the debugger, the debug perspective of a graphical user interface (‘GUI’) to the thread triggering the watch event; and
if the watch event was not set for the thread triggering the watch event:
retrieving, by the debugger, watch event information from the thread triggering the watch event; and
resuming, by the debugger without user interaction, execution of the thread triggering the watch event.

2. The method of claim 1, further comprising stopping, by the debugger, execution of the thread for which the watch event was set if the watch event was not set forth the tread triggering the watch event.

3. The method of claim 2, further comprising displaying, by the debugger in the GUI, information describing the thread for which the watch event was set along with the watch event information retrieved from the thread triggering the watch event.

4. The method of claim 1, further comprising setting, by the debugger, a watch event for a thread.

5. The method of claim 1, wherein the watch event information further comprises a location in source code of one or more computer program instructions being executed and triggering the watch event.

6-17. (canceled)
